(19) United States
(12) Patent Application Publication
(10) Pub. No.: US 2026/0259044 A1
(43) Pub. Date: Sep. 3, 2026

(54) Focus Variation Apparatus and Method

(71) Applicant: University of Huddersfield, Huddersfield (GB)

(72) Inventors: Hussam Muhamedsalih, Huddersfield (GB); Dawei Tang, Huddersfield (GB); Aalim Mustafa, Huddersfield (GB); Prashant Kumar, Huddersfield (GB); Xiang Jiang, Huddersfield (GB)

(21) Appl. No.: 19/164,692

(22) PCT Filed: Mar. 13, 2024
(86) PCT No.: PCT/GB2024/050677

§ 371 Date: Sep. 12, 2025

(30) Foreign Application Priority Data
Mar. 13, 2023 (GB) 2303620.5

(51) Int. Cl. G01B 11/30; G01B 11/25; G01N 21/88

(52) U.S. Cl. CPC G01B 11/303; G01B 11/2518; G01N 21/8806; G01N 21/8851; G01B 2210/50

(57) ABSTRACT

A focus variation optical apparatus suitable for measuring surface features of materials or substrates and method of use thereof. The apparatus includes at least one light source means and at least one light source means configured to direct a light beam to a mask means. The mask means is configured to project an illumination pattern on the material or substrate and an image sensor is employed to collect images of the surface illuminated by the projected pattern.

The present invention relates to an apparatus and method to measure a wide range of surface features.

Surface science has become an important part of the wide engineering landscape and will play a vital role in the future development of next-generation products and technologies. Surface measurement can be used to guarantee the functionality of high precision workpiece and production control, enabling better manufacturing throughput and cost reduction. Functional surfaces can be produced at different length scales and spatial frequencies; yet they may contain contamination/defects that would suddenly change the surface type from smooth and structured surfaces to ‘stochastic’ surfaces. One of the challenges is that this wide range of surfaces need a hierarchy of metrology instrumentation for characterization and measurement of features at different scales, leading to a large investment in metrology equipment by manufacturers. Conventionally, defects can be measured using a focus variation microscope, but with a large amount of bad data across a smooth surface. While interferometric methods such as a white light interferometer can successfully measure the smooth surface but with bad data at the defect positions.

The other challenge is that most commercial-use optical instruments are still laboratory-based and need further development to be implemented for in-process measurement applications. For instance, areal surface topography measurement is usually achieved slowly by capturing multiple frames during a vertical mechanical scanning pass or mechanism. The scanning time of mechanical mechanisms such as those in the white light interferometry and focus variation systems is considered a limiting factor for fast quality control of modern advanced manufacturing. Therefore, it is in high demand to remove the mechanical scanning as well as actively stabilise the system to compensate for the environmental vibration and disturbances.

It is therefore an aim of the present invention to provide an apparatus for measuring a wide range of surface features that addresses the abovementioned problems.

It is a further aim of the present invention to provide a method of measuring a wide range of surface features that addresses the abovementioned problems.

It is a yet further aim of the present invention to provide an optical system that addresses the abovementioned problems.

In the first aspect of the invention, there is provided a focus variation optical apparatus suitable for measuring surface features of materials or substrates, said apparatus including a light source means configured to direct a light beam to a mask means, wherein said mask means configured to project an illumination pattern on material or substrate surface and an image sensor is employed to collect images of the surface illuminated by the projected pattern.

As such the apparatus is a chromatic focus variation (CFV) instrument to measure a wide range of surface features with different length scales using a single unique optical setup. Typically the CFV removes the need for mechanical movement by employing a chromatic objective with wavelength scanning.

Typically the image sensor is a camera means.

In a preferred embodiment of the invention, the apparatus includes a collimator. Typically said collimator is associated with the light source means to direct collimated light beams to the mask means.

In a preferred embodiment the mask means generates and/or projects a polarised mask or pattern. Typically the mask means generates and/or projects a pixellated illumination pattern. Further typically the pixellated illumination pattern is at different intensity levels. Typically the pixellated polarised mask generates and/or projects a periodic pattern on the surface.

In a preferred embodiment the apparatus includes a chromatic lens. Typically the chromatic lens is an objective lens used to scan the focus plane. Further typically the chromatic lens is used to scan the focus plane across the optical axis without any mechanical movement.

Typically the light source is a tuneable light source. In one embodiment the light source includes an acousto-optic tuneable filter (AOTF).

In one embodiment of the invention the system includes a stabilisation means to compensate for environmental vibration and enhance in-process measurements.

In one embodiment the stabilisation means includes a compensating piezoelectric translator (PZT) attached to the chromatic objective lens.

Typically the PZT is controlled by a Proportional Integral (PI) controller to track the sample movement. Further typically the stabilisation means comprises a PZT attached to the chromatic objective lens to stabilise the chromatic focus variation. Optionally a feedback signal is generated by the Chromatic Focus Variation (CFV) optical configuration and detected/captured by a spectrometer to track the peak location.

In one embodiment this feature can also be used for auto-focus purposes. Typically, if the PI controller is switched off, the peak position obtained from the spectrometer after scanning the PZT will indicate the focus position.

In one embodiment a feedback signal is separated from the main measurement signal by a beam splitter located before the image sensor and after a lense. Typically the lense is a tube lens.

In one embodiment a pinhole is placed at the focal plane of the tube lens followed by a detector to record the feedback signal.

In one embodiment a detector means includes a pinhole member. Typically the pinhole and the detector are used to detect the intensity variation caused by the vibration.

Typically the apparatus includes a light direction means that may comprise one or more beam splitters. Further typically the light source or sources may be remote from the rest of the apparatus, for example a fibre optic coupling may be used to couple the light source or light sources to the light direction means.

The image sensor may comprise a CCD or CMOS camera.

Typically the image sensor is configured to capture a series of images of the surface illuminated by the projected pattern.

In one embodiment the AOTF is used to sequentially filter a narrow line-width wavelength from a visible broadband light.

Typically during wavelength and/or focus scanning, the image sensor or camera captures images of the surface illuminated by the projected pattern. Surface contrast is apparent at the focus position without the need to have sufficient features to produce a shape image, due to the projected pattern. This is a key feature to measure smooth surfaces using this focus variation method.

In the second aspect of the invention, there is provided a method of measuring surface features using chromatic focus variation, said method including the steps of directing a light beam to a polarised mask to create a pixelated illumination pattern at different intensity levels, projecting the periodic pattern on the measurand surface and recording an image using an image sensor or camera of the tested surface wherein a chromatic lens is used to scan the focus plane across the optical axis, typically without any substantive mechanical movement.

In a third aspect of the invention there is provided a focus variation system suitable for measuring surfaces and surface features of materials or substrates, said system including a light source means configured to direct a light beam to a mask means, wherein said mask means configured to project an illumination pattern on material or substrate surface and an image sensor collect images of the surface illuminated by the projected pattern wherein a chromatic lens is used to scan across the optical axis.

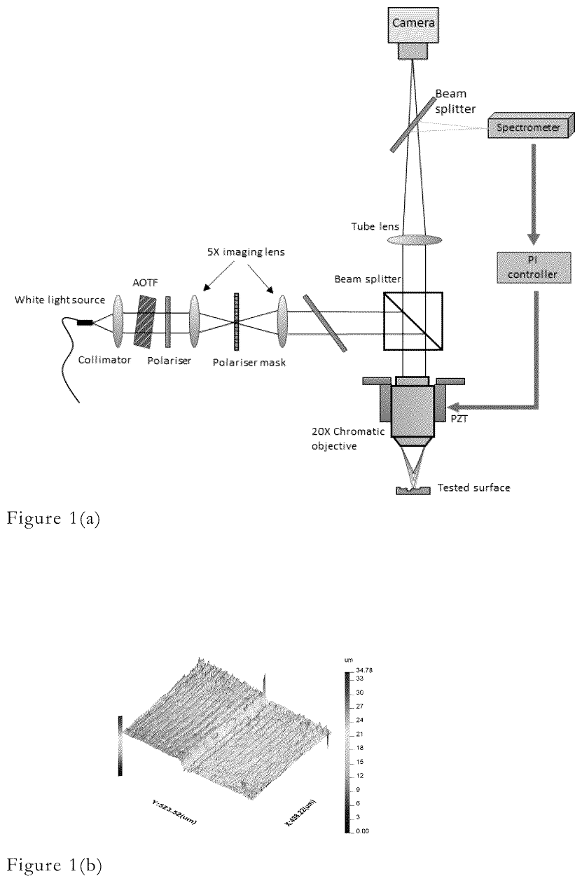

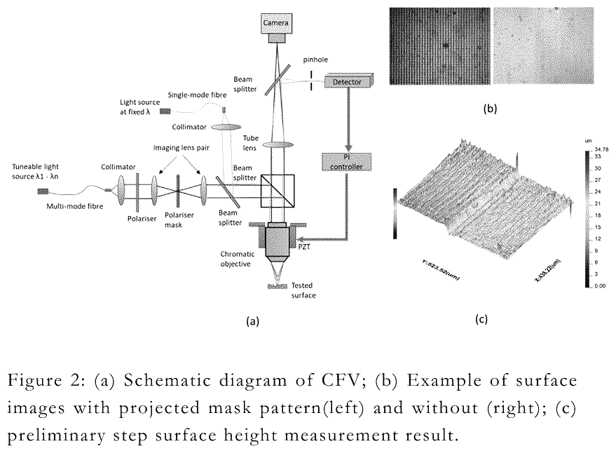

Specific embodiment of the invention are now described with reference to the following figures wherein:
FIGS. 1 and 2 shows a device in accordance with one embodiment of the invention.

The present invention is a chromatic focus variation (CFV) instrument 2 to measure a wide range of surface 4 features with different length scales using a single unique optical setup. The CFV removes the need for mechanical movement by employing a chromatic objective 6 with wavelength scanning. Optionally this instrument can be made robust against environmental disturbances by including a built-in active vibration compensation system.

The proposed instrument is capable of measuring both rough and smooth surfaces, with a height range of up to 100 μm using a 20× chromatic objective. By developing these unique measurement capabilities, CFV will evolve existing state-of-the-art focus variation technologies.

This unique focus variation instrument can measure both smooth and rough surfaces for two-dimensional materials during manufacturing. The important elements are a) the use of a pixelated polarised mask 8 to generate a periodic pattern on the surface to allow both smooth and rough surface measurement using focus variation technique; b) the use of a chromatic objective lens 6 with wavelength scanning to remove the need for mechanical movement; c) optionally the use of an active stabilisation system to compensate for the environmental vibration to enable in-process measurement of CFV; d) optionally the use of PZT and spectrometer can also be used for fast auto-focus before performing the measurement

### Operation Principle

The novel focus variation setup for areal measurement is shown in FIG. 1(a) and 2(a). A collimated polarised beam 12 will be directed to a polarised phase mask 8 to create a pixelated illumination pattern at different intensity levels, see FIG. 2(b). The intensity of individual pixels within the pattern is determined by the polarization angle associated with each pixel on the mask. Maximum intensity is achieved when the polarization of the incident light is in-phase, while minimum intensity is attained when the light polarization is out-of-phase.

This periodic pattern will be projected on the measurand and finally imaged to a camera 14 with the tested surface. A chromatic lens 6, having a linear chromatic focus shift up to 100 μm (corresponding to wavelength scanning from 486 nm to 656 nm), was employed to scan the focus plane across the optical axis without any mechanical movement. In one example an acousto-optic-tunable-filter (AOTF) 16 was used to sequentially filter a narrow line-width wavelength from a visible broadband light 18. Alternatively, a tuneable laser source 20 can also be used for illumination. In the example given in FIG. 2, the tunable light source is combined with a fixed wavelength light source 36.

During the wavelength scanning, the corresponding focus shift will be induced and the camera 14 will capture a series of images of the surface illuminated by the projected pattern. The best surface contrast can be easily detected at the focus position without the need to have sufficient features to produce a shape image, thanks to the projected pattern. This is a key feature to measure smooth surfaces using the focus variation method. A feasibility study was recently conducted by measuring a 3 μm step height sample with mirror finished surface. The preliminary result, shown in FIG. 2(c), suggests the potential of using the proposed system for surface measurement. This figure shows a step surface height equal to 2.971 μm without bad data across the measurement area.

The CFV system can have a built-in active close-loop stabilisation system 10 to compensate the environmental disturbances and stabilise the CFV, enabling on-machine/in-line measurements. It consists of a PZT 22 attached to the chromatic objective lens 6 and a PI controller 24 to control the PZT to track the sample movement. The feedback signal can be generated from a multiplexed chromatic confocal microcopy that shares the same optical path as of CFV. The feedback signal will be separated from the main measurement signal by the beam splitter 26 located before the camera. In the FIG. 2 example a pinhole 28 is placed at the focal plane of the tube lens 30 followed by a detector 32 to record the feedback signal. In the example in FIG. 1(a) a spectrometer 34 is employed in the place of the pinhole and detector.

1. A focus variation optical apparatus suitable for measuring surface features of materials or substrates, said focus variation optical apparatus comprising:
a light source means being a tunable laser source or a broadband light source with an acousto-optic tunable filter (AOTF),
a chromatic objective lens,
wherein the light source means is configured to direct a light beam to a mask means,
wherein said mask means is configured to project an illumination pattern on material or substrate surface,
an image sensor is employed to collect images of a surface illuminated by the projected pattern, and
wherein the chromatic objective lens scans a focus plane across the optical axis without any mechanical movement.

2. Apparatus according to claim 1 wherein the image sensor is a camera means.

3. Apparatus according to claim 1 wherein the apparatus includes a collimator associated with the light source means to direct collimated light beams to the mask means.

4. Apparatus according to claim 2 wherein the mask means generates and/or projects a polarised mask or pattern.

5. Apparatus according to claim 4 wherein the mask means generates and/or projects a pixellated illumination pattern.

6. Apparatus according to claim 5 wherein the pixellated illumination pattern is at different intensity levels.

7. Apparatus according to claim 6 wherein the pixellated polarised mask generates and/or projects a periodic pattern on the surface.

8-12. (canceled)

13. Apparatus according to claim 1 wherein the apparatus includes a stabilisation means configured to compensate for environmental vibration and enhance in-process measurements.

14. Apparatus according to claim 13 wherein the stabilisation means includes a compensating piezoelectric translator (PZT) attached to the chromatic objective lens.

15. Apparatus according to claim 14 wherein the piezoelectric translator (PZT) is controlled by a Proportional Integral (PI) controller to target a sample movement.

16. Apparatus according to claim 15 wherein the stabilisation means comprises a piezoelectric translator (PZT) attached to the chromatic objective lens to stabilise the chromatic focus variation.

17. Apparatus according to claim 16 wherein a feedback signal is generated by the Chromatic Focus Variation (CFV) optical configuration and detected/captured by a spectrometer to track a peak location.

18. Apparatus according to claim 1 wherein the apparatus includes a light direction means that may comprise one or more beam splitters.

19. Apparatus according to claim 2 wherein the image sensor comprises at least one of a charge-coupled device (CCD) or complimentary metal-oxide semiconductor (CMOS) camera.

20. Apparatus according to claim 19 wherein the image sensor is configured to capture a series of images of the surface illuminated by the projected pattern.

21. (canceled)

22. Apparatus according to claim 1 wherein the apparatus includes two light source means.

23. Apparatus according to claim 22 wherein at least one of the light source means has a fixed wavelength.

24. Apparatus according to claim 22 wherein the tuneable light source provides light via a multi-mode fibre.

25. Apparatus according to claim 24 wherein the fixed wavelength light source provides light via a single mode fibre.

26. A method of measuring surface features using chromatic focus variation, said method including the steps of directing a light beam to a polarised mask to create a pixelated illumination pattern at different intensity levels, projecting the periodic pattern on the measurand surface and recording an image using an image sensor or camera of the tested surface wherein a chromatic lens is used to scan the focus plane across the optical axis, typically without any substantive mechanical movement.
